(19) United States
(12) Patent Application Publication
(10) Pub. No.: US 2021/0396236 A1
(43) Pub. Date: Dec. 23, 2021

(54) VACUUM PUMP WITH A SOLENOID VALVE

(71) Applicant: MILWAUKEE ELECTRIC TOOL CORPORATION, Brookfield, WI (US)

(72) Inventors: Aaron C. Grode, Germantown, WI (US); Justin Miller, Richfield, WI (US)

(21) Appl. No.: 17/346,364

(22) Filed: Jun. 14, 2021

Related U.S. Application Data
(60) Provisional application No. 63/040,766, filed on Jun. 18, 2020.

(51) Int. Cl. F04D 25/06; F04D 19/04; F04D 27/02; F16K 31/06

(52) U.S. Cl. CPC F04D 25/0673; F16K 31/0675; F04D 27/0207; F04D 19/04

(57) ABSTRACT

A vacuum pump includes a housing defining a base, an internal cavity, and a partition wall defining a first chamber and a second chamber. The second chamber is sealed relative to the first chamber to form a compression chamber. A motor assembly and an electronic control unit are positioned within the first chamber. A pump assembly is positioned within the compression chamber and in communication with the lubrication fluid and the motor assembly. A battery is coupled to the housing to provide power to the motor assembly to drive the pump assembly. An inlet is coupled to the housing to connect the vacuum pump to an external system. A fluid pathway extends between the inlet and a pump inlet of the pump assembly. A valve is positioned within the fluid pathway that selectively opens and closes the fluid pathway and is biased towards a closed position.

### CROSS-REFERENCE TO RELATED APPLICATIONS

The present application claims priority to co-pending U.S. Provisional Patent Application No. 63/040,766, filed on Jun. 18, 2020, the entire content of which is incorporated herein by reference.

### FIELD OF THE INVENTION

The present invention relates to a pump, and more particularly to a vacuum pump.

### BACKGROUND OF THE INVENTION

Vacuum pumps may be used to remove or evacuate materials such as unwanted air, gas, and non-condensables, such as water vapor, from an external system (e.g., an air conditioning system, a refrigeration system, etc.). Vacuum pumps may be used to evacuate the external system before the system is charged with refrigerant or when the existing system is undergoing repair (e.g., the refrigerant is already recovered). The vacuum pump may be connected to high- and low-pressure sides of the external system via hoses and a manifold. During operation, the vacuum pump creates a low-pressure zone that draws the unwanted materials such as air and non-condensables out of the external system, which has a high pressure, and into the vacuum pump. Since the vacuum pump has a low internal pressure, there is a desire to reduce vacuum decay (e.g., loss of internal pressure) of the vacuum pump during power loss or accidental disconnection of the pump from the external system.

### SUMMARY OF THE INVENTION

The present invention provides, in one aspect, a vacuum pump including a housing defining a base, an internal cavity, and a partition wall that defines a first chamber and a second chamber within the internal cavity. The second chamber being sealed relative to the first chamber to form a compression chamber that holds a lubrication fluid. A motor assembly positioned within the first chamber of the housing. An electronic control unit positioned within the first chamber of the housing, the electronic control unit configured selectively activate and deactivate the motor assembly. A pump assembly positioned within the compression chamber and in communication with the lubrication fluid and the motor assembly. A battery coupled to the housing to provide power to the motor assembly to drive the pump assembly. An inlet coupled to the housing to connect the vacuum pump to an external system. A fluid pathway extending between the inlet and a pump inlet of the pump assembly. A valve positioned within the fluid pathway that selectively opens and closes the fluid pathway, the valve being biased towards a closed position to restrict flow through the fluid pathway.

The present invention provides, in another aspect, a vacuum pump including a housing defining an internal cavity and a partition wall that defines a first chamber and a second chamber within the internal housing. The second chamber is sealed relative to the first chamber to form a compression chamber that holds a lubrication fluid. A motor assembly positioned within the first chamber of the housing. An electronic control unit positioned within the first chamber of the housing. A pump assembly positioned within the compression chamber and in communication with the lubrication fluid and the motor assembly. A battery coupled to the housing to provide power to the motor assembly to drive the pump assembly. An inlet coupled to the housing to connect the vacuum pump to an external system. A fluid pathway extending between the inlet and a pump inlet of the pump assembly. A solenoid valve positioned within the fluid pathway that selectively opens and closes the fluid pathway in response to a signal from the electronic control unit.

Other features and aspects of the invention will become apparent by consideration of the following detailed description and accompanying drawings.

### BRIEF DESCRIPTION OF THE DRAWINGS

FIG. 1 is a left side, perspective view of a vacuum pump according to an embodiment of the invention.

FIG. 2 is a right perspective view of the vacuum pump of FIG. 1.

FIG. 3 is a left perspective, cross-sectional view of the vacuum pump of FIG. 1.

FIG. 4 is a left side, cross-sectional view of the vacuum pump of FIG. 1.

FIG. 5 is a front perspective, cross-sectional view of the vacuum pump of FIG. 1.

FIG. 6 is a left side, partial cutaway view of the vacuum pump of FIG. 1 illustrating a solenoid valve.

FIG. 7 is a left perspective, cross-sectional view of the vacuum pump of FIG. 1 illustrating a portion of a fluid pathway.

FIG. 8 is a left perspective, cross-sectional view of the vacuum pump of FIG. 1 illustrating a portion of the fluid pathway

FIG. 9 is a side cross-sectional view of a check valve, which may be used with the vacuum pump of FIG. 1.

FIG. 10 is a side cross-sectional view of a poppet valve, which may be used with the vacuum pump of FIG. 1.

FIG. 11 is a side cross-sectional view of a motor actuated ball valve, which may be used with the vacuum pump of FIG. 1.

FIG. 12 is a side cross-sectional view of a pilot valve, which may be used with the vacuum pump of FIG. 1.

FIG. 13 is a side cross-sectional view of a spool valve, which may be used with the vacuum pump of FIG. 1.

Before any embodiments of the present subject matter are explained in detail, it is to be understood that the present subject matter is not limited in its application to the details of construction and the arrangement of components set forth in the following description or illustrated in the following drawings. The present subject matter is capable of other embodiments and of being practiced or of being carried out in various ways.

### DETAILED DESCRIPTION

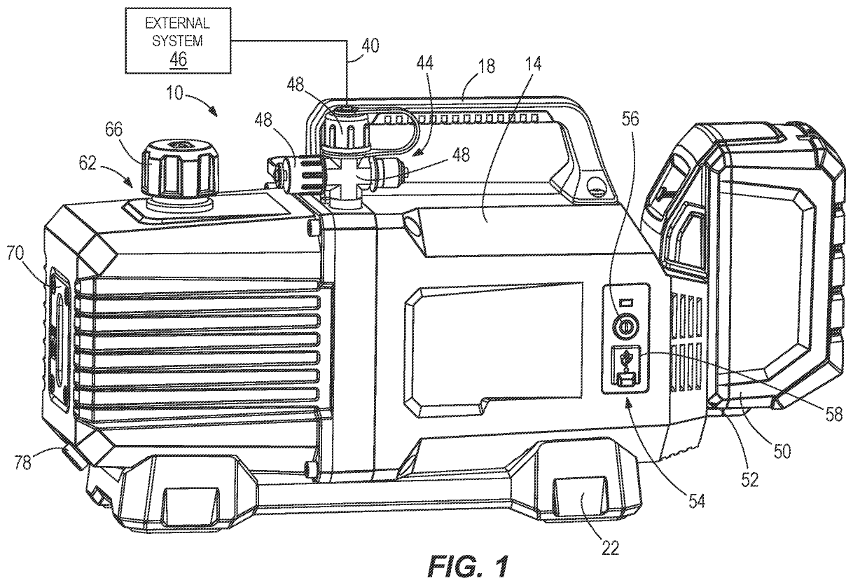

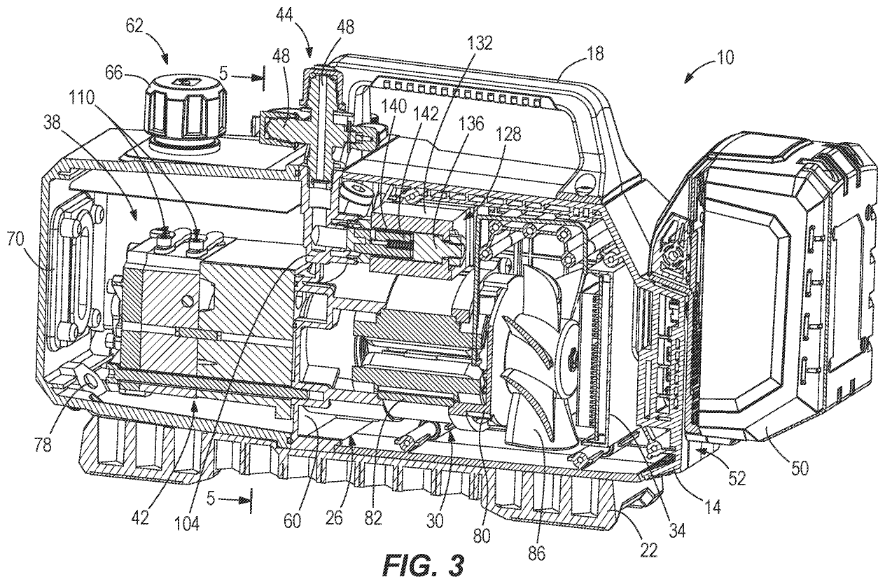

With reference to FIGS. 1-4, a vacuum pump 10 includes a housing 14, a handle 18 coupled to an upper portion of the housing 14, and a base 22 coupled to a lower portion of the housing 14 to support the vacuum pump 10 relative to the ground. The housing 14 defines an internal cavity (FIG. 3) that has a first chamber 26 that houses, protects, and/or conceals a motor assembly 30, an electronic control unit 34, and other electronic components, and a second chamber (i.e., a compression chamber 38) that houses a pump assembly 42.

With reference to FIG. 1, an inlet 44 is positioned on an upper portion of the housing 14 and is in communication with the pump assembly 42. The inlet 44 is fluidly connected to a hose 40 that connects the vacuum pump 10 to an external system 46 (e.g., an air conditioning system, a refrigeration system, etc.). In the illustrated embodiment, the inlet 44 includes multiple connection ports 48 that are sized to connect to the hose that is coupled to the external system 46. For example, the connection ports 48 may have various sizes (e.g., ½ inch, ¼ inch, etc.).

A battery pack 50 is removably coupled to an end portion of the housing 14 via a battery receptacle 52. The battery pack 50 provides power to the motor assembly 30 that drives the pump assembly 42 to remove or evacuate material such as air, gas, and non-condensables (e.g., water vapor) from the external system 46. The vacuum pump 10 includes a control panel 54 on a sidewall of the housing 14. In the illustrated embodiment, the control panel 54 includes a power switch 56 that selectively activates the vacuum pump 10 and a Universal Serial Bus (USB) port 58. In some embodiments, an external display may be connected to the USB port 58 to display information related to the operation of the vacuum pump 10 (e.g., battery life remaining, micron gauge, etc.). In other embodiments, the control panel 54 may include a display (e.g., an LCD display).

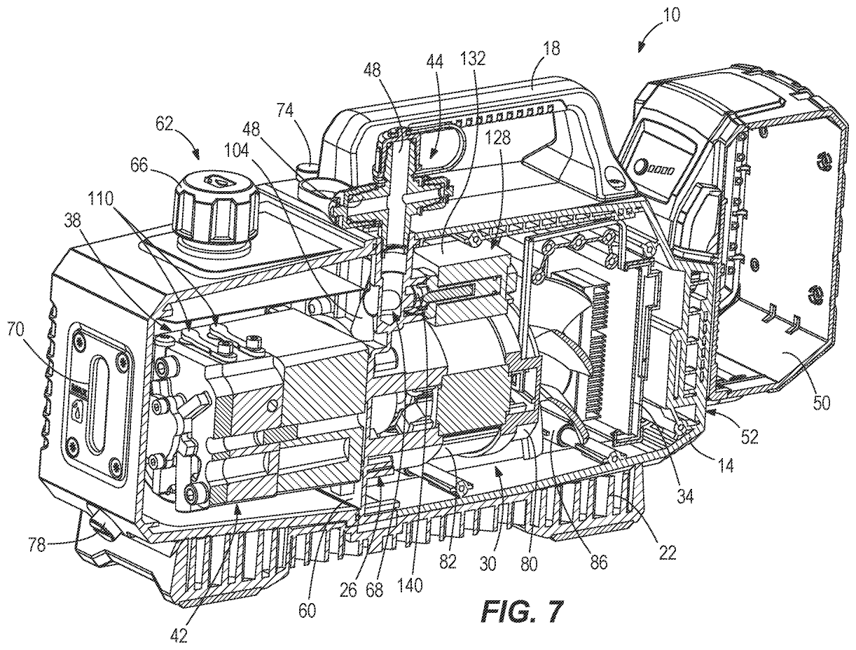

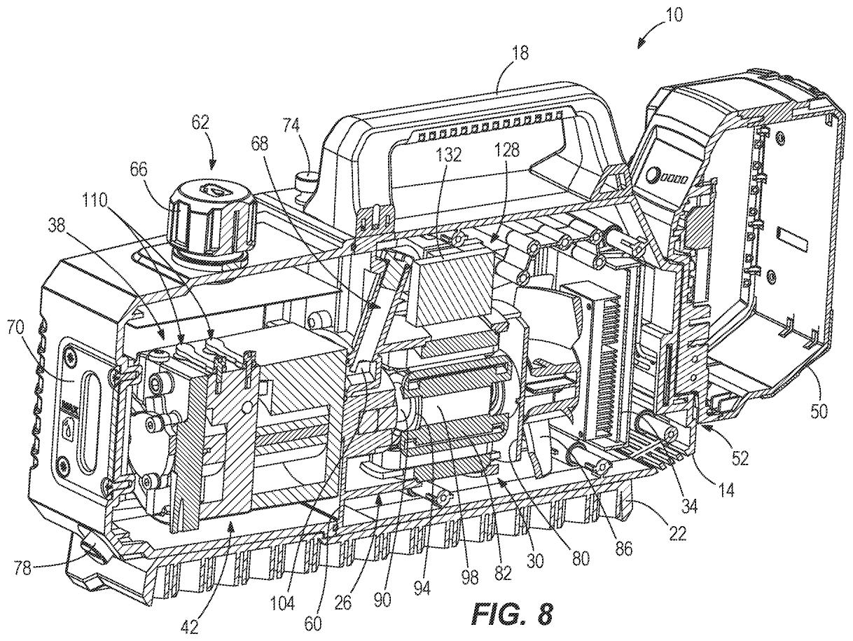

With reference to FIG. 3A-3C, the compression chamber 38 is sealed relative to the first chamber 26 via a partition wall 60 so the compression chamber 38 can hold lubrication fluid (e.g., oil). In the illustrated embodiment, the partition wall 60 defines a fluid pathway 68 (illustrated in FIGS. 7 and 8) that extends between the inlet 44 and the pump assembly 42. The lubrication fluid positioned within the compression chamber 38 is used to lubricate and cool the pump assembly 42 during operation of the vacuum pump 10.

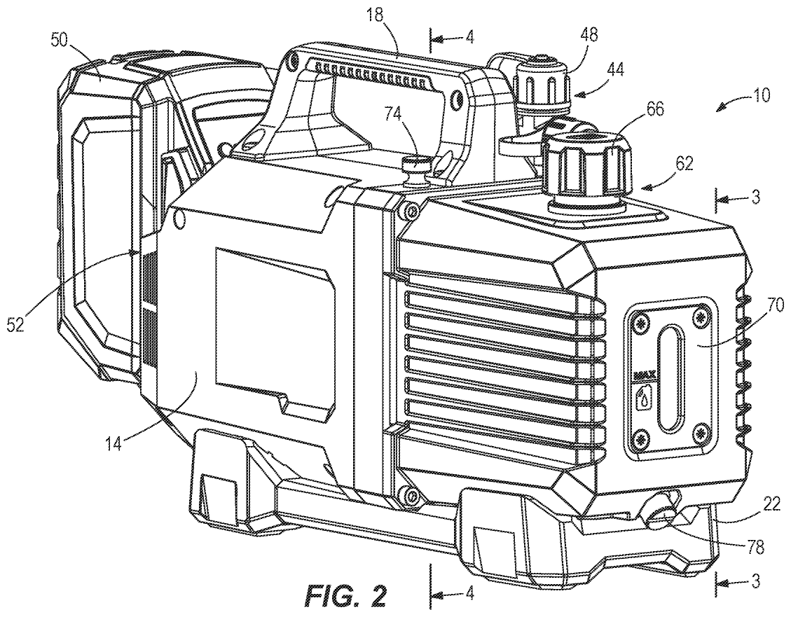

Now with reference to FIG. 2, the compression chamber 38 further includes a fluid port 62 having a removable cap 66, a fluid gauge 70 positioned on a sidewall of the housing 14, a release valve 74 positioned on the upper portion of the housing 14, and a fluid drain valve 78 positioned proximate the base 22. In the illustrated embodiment, the fluid port 62 and the removable cap 66 also function as an exhaust during operation of the vacuum pump 10. The fluid gauge 70 may be transparent to allow a user to determine the amount of lubrication fluid that is held within the compression chamber 38. The fluid drain valve 78 allows the user to drain the lubricant from the compression chamber 38.

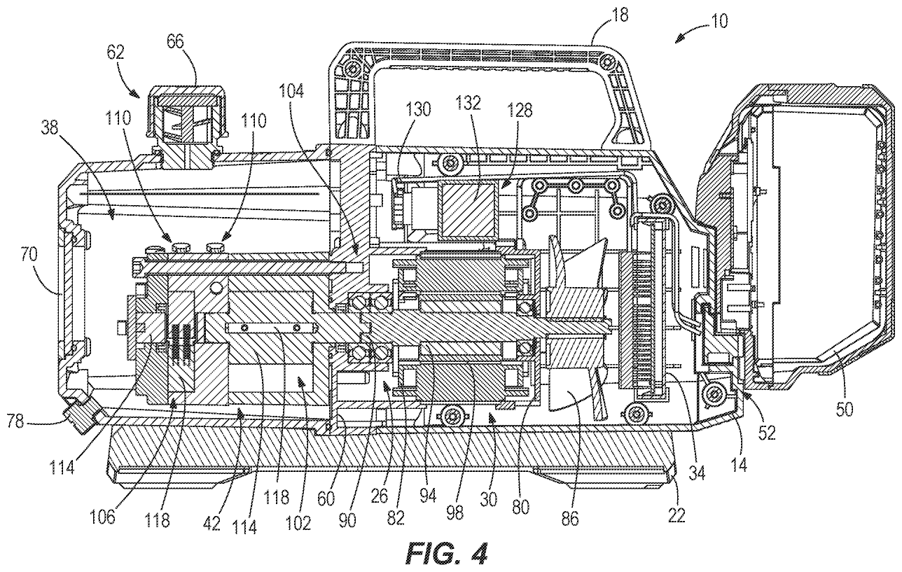

Now with reference to FIG. 4, the motor assembly 30 is positioned within the first chamber 28 and is coupled to the partition wall 60 via a support bracket 80. The motor assembly 30 includes a motor 82 and a fan 86 driven by the motor 82. In the illustrated embodiment, the motor 82 is a brushless direct current (BLDC) motor that has a motor shaft 90 having a first end coupled to the fan 86 and a second end coupled to the pump assembly 42, a rotor 94 coupled to the motor shaft 90, and a stator 98 surrounding the rotor 94. During operation of the motor 82, an electrical current flows through coils of the stator 98 to produce a magnetic field around the rotor 94, which causes the motor shaft 90 to rotate and drive the pump assembly 42. While the illustrated motor 82 includes the rotor 94 and the stator 98, it should be appreciated that the vacuum pump 10 may include any DC motor that converts direct current electrical energy into mechanical energy such as a series DC motor (e.g., having electromagnets connected in series), a shunt DC motor, or a compound DC motor. The fan 86 is positioned between the electronic control unit 34 and the motor assembly 30. The fan 86 removes heat from the electronic control unit 34 and provides air to the motor assembly 30 to prevent overheating of each of the electronic control unit 34 and the motor assembly 30.

With continued reference to FIG. 4, the pump assembly 42 is a two-stage pump that has a first pump chamber 102 and a second pump chamber 106 in series with the first pump chamber 102. The first pump chamber 102 has a pump inlet 104 in communication with a fluid pathway 68 (illustrated in FIGS. 7 and 8) that extends between the inlet 44 and an outlet in communication with the second pump chamber 106. The second pump chamber 106 has an outlet 110 that releases the pressure from the pump assembly 42 to the compression chamber 38. While the illustrated pump assembly 42 is a two-stage pump (e.g., has first and second pump chambers), it should be appreciated that the pump assembly 42 may only include a single stage or chamber.

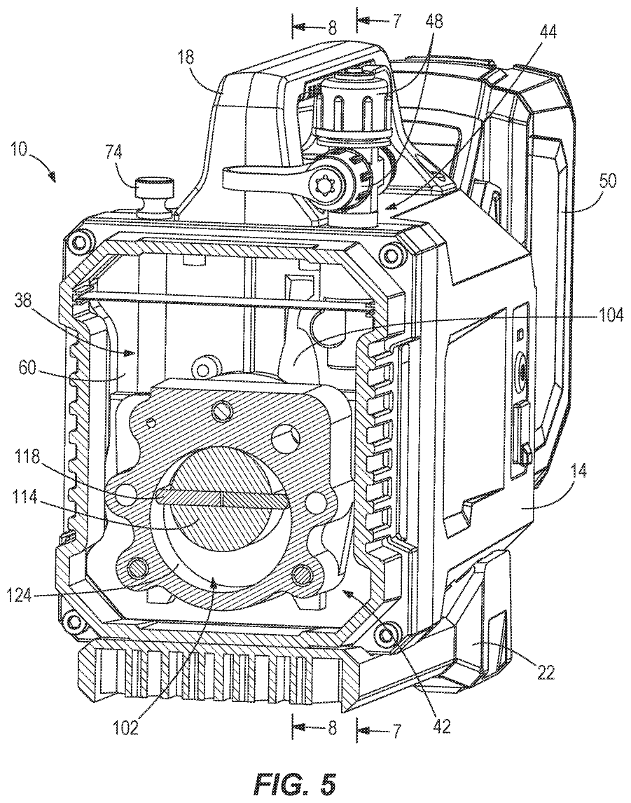

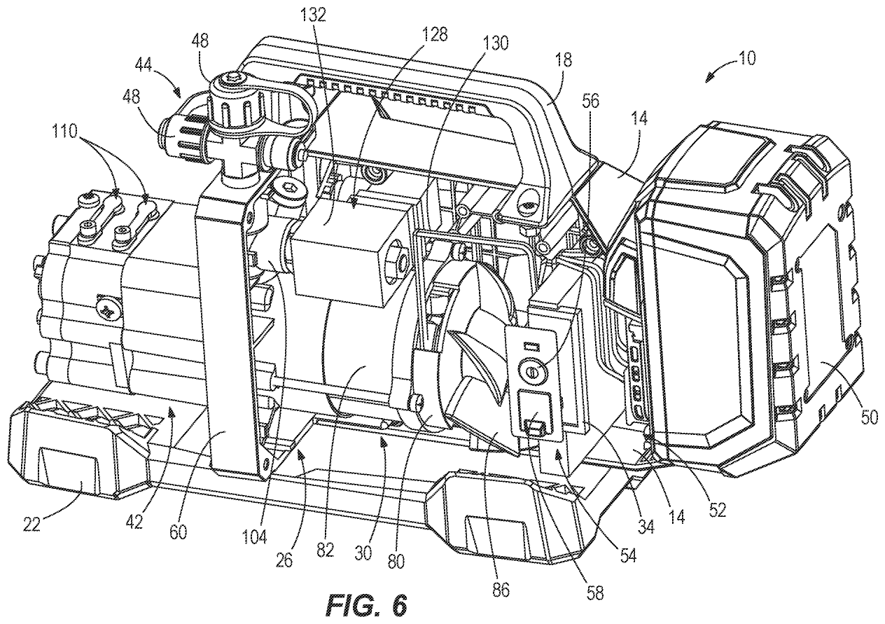

Now with reference to FIGS. 4 and 5, each of the first and second pump chambers 102, 106 includes an eccentrically mounted rotor 114 having vanes 118 that are biased (e.g., by springs) towards an outer wall 124 of the pump chambers 102, 106 (FIG. 5). As a result, the rotation of the eccentrically mounted rotors 114 creates low pressure regions within the pump assembly 42, which draw material out of the external system 46 (FIG. 1) and into the pump assembly 42. The materials are transferred from the first pump chamber 102 to the second pump chamber 106, and are then discharged into the compression chamber 38 via the outlet 110. In the illustrated embodiment, the outlet 110 includes a valve (e.g., a reed valve) that selectively releases the materials into the compression chamber 38 before the materials are released from the exhaust (e.g., via the cap 66) of the compression chamber 38.

Now with reference to FIG. 4, the vacuum pump 10 includes a solenoid valve 128 that is electrically connected to the electronic control unit 34 by electrical wires 130. The solenoid valve 128 is coupled to the partition wall 60 and selectively closes the fluid pathway 68 extending between the inlet 44 and the pump inlet 104. In other words, the solenoid valve 128 is integrated within the housing 14 of the vacuum pump 10 and directly communicates with the electronic control unit 34 of the vacuum pump 10.

Now with reference to FIG. 3, the solenoid valve 128 has a valve body 132 that houses an armature 136 and a solenoid coil that surrounds the armature 136. The armature 136 defines a recess that receives a plunger 140 and a biasing member (e.g., a spring 142). The spring 142 urges the plunger 140 towards a closed position so the plunger 140 closes the fluid pathway 68 extending between the inlet 44 and the pump inlet 104.

Now with reference to FIGS. 7 and 8, the fluid pathway 68 extending between the inlet 44 and the pump inlet 104 is illustrated. The fluid pathway 68 has a first portion (FIG. 7) that extends vertically from the inlet 44 towards the base 22 and a second portion (FIG. 8) that extends diagonally from an end of the first portion of the fluid pathway 68 towards the pump inlet 104. The solenoid valve 128 is coupled to the partition wall 60 so the plunger 140 can selectively move within the first portion of the fluid pathway 68 to close the fluid pathway 68.

The electronic control unit 34 is in electronic communication with the solenoid coil of the solenoid valve 128 to selectively move the plunger 140 within the armature 136 (e.g., against the spring 142) in response to a signal from the electronic control unit 34. Movement of the plunger 140 toward an open position (FIG. 7) opens the fluid pathway 68 between the inlet 44 and the pump inlet 104 so materials and fluid from the external system 46 can enter the pump assembly 42. In other words, the flow of material through the solenoid valve 128 can be controlled by energizing or de-energizing the solenoid coil.

During operation, a user may attach the battery pack 50 to the battery receptacle 52 of the vacuum pump 10, and fluidly connect the external system 46 to the vacuum pump 10 via the inlet 44 (e.g., with the hose 40). The user may activate the vacuum pump 10 with the control panel 54 (e.g., by depressing the power switch 56) to activate the motor assembly 30 and begin removing unwanted material from the external system 46. When the vacuum pump 10 is activated, the electronic control unit 34 outputs an electrical current to the solenoid valve 128 (e.g., via the electrical wires 130), which produces a magnetic field that moves the plunger 140 to an open position (e.g., by compressing the spring 142). If the hose is inadvertently disconnected or if the charge of the battery pack 50 is depleted or otherwise interrupted, the electrical current provided to the solenoid valve 128 is also interrupted, therefore removing the magnetic field from the solenoid coil and permitting the spring 142 to rebound and return the plunger 140 to the closed position. In the closed position, the plunger 140 closes the fluid pathway 68 between the inlet 44 and the pump inlet 104 and restricts the fluid or material from entering the pump assembly 42. At the same time, the solenoid valve 128 limits the amount of vacuum decay that occurs within the compression chamber 38 and prevents backflow of the lubricant from within the compression chamber 38 through the inlet 44. As a result, the vacuum pressure within the compression chamber 38 remains at a near constant state, which allows the user to replace the battery 50 and continue the evacuation process of the external system 46.

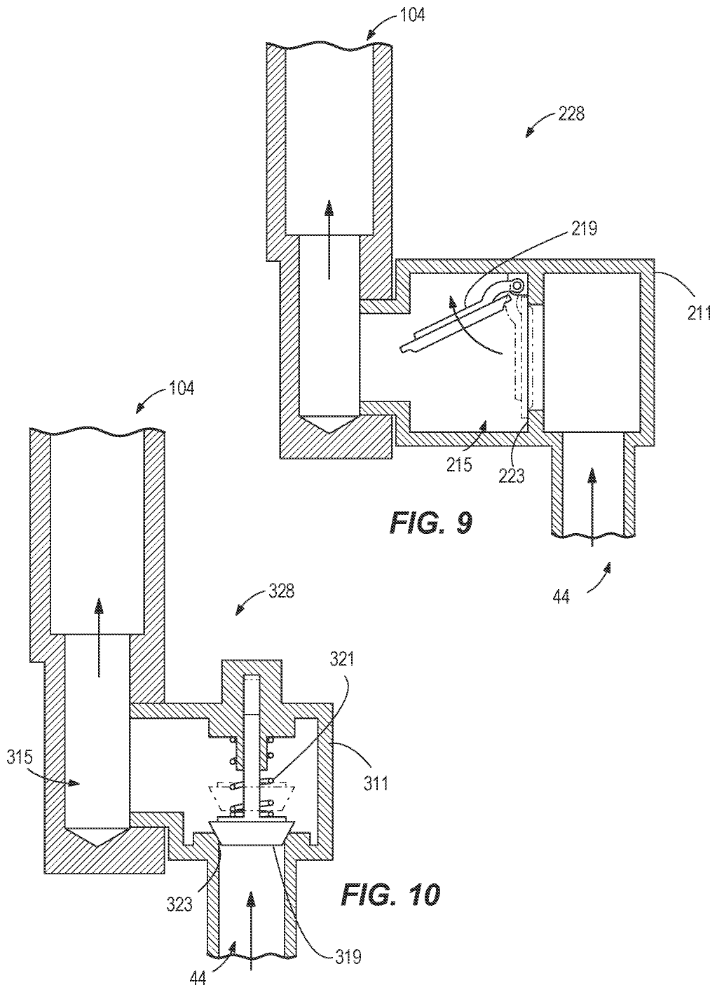

FIGS. 9-13 illustrate various valves which may be used with the vacuum pump 10 described in detail above. The valves described below may be used with the vacuum pump 10 instead of the solenoid valve 128 to selectively closes the fluid pathway 68 extending between the inlet 44 and the pump inlet 104. The valves may be used to restrict the fluid or material from entering the pump assembly 42, limit the amount of vacuum decay that occurs within the compression chamber 38, and prevent backflow of the lubricant from within the compression chamber 38 through the inlet 44

As shown in FIG. 9, a check valve 228 may be fluidly connected to the fluid pathway 68 extending between the inlet 44 and the pump inlet 104. In the illustrated embodiment, the check valve 228 includes a body 211 defining a flow path 215, and a disc 219 pivotably connected to the body 211 to selectively restrict flow through the flow path 215. When the pump assembly 42 is activated, the disc 219 swings off seat 223 to allow forward flow. Once the pump is deactivated, the flow of the fluid is stopped, which causes the disc 219 to swing back onto the seat 223 to block reverse flow. When the check valve 228 is in a closed position (illustrated with dashed lines), the disc 219 abuts a seat 223 to seal the flow path 215, which restricts the fluid or material from entering the pump assembly 42, limits the amount of vacuum decay that occurs within the compression chamber 38, and prevents backflow of the lubricant from within the compression chamber 38 through the inlet 44.

As shown in FIG. 10, a poppet valve 328 may be fluidly connected to the fluid pathway 68 extending between the inlet 44 and the pump inlet 104. In the illustrated embodiment, the poppet valve 328 includes a body 311 defining a flow path 315 with an orifice or seat 323, and a plunger 319 biased into engagement with the seat 323 via a biasing member 321 to selectively restrict flow through the flow path 315. When the pump assembly 42 is activated, the flow urges the plunger 319 out of engagement with the seat 323 (e.g., against the force of the biasing member, shown with dashed lines) to allow forward flow. Once the pump assembly 42 is deactivated, the flow of the fluid is stopped, which causes the biasing member 321 to urge the plunger 319 into engagement with the seat 323 to block reverse flow. When the poppet valve 328 is in a closed position, the plunger 319 abuts the seat 323 to seal the flow path 315, which restricts the fluid or material from entering the pump assembly 42, limit the amount of vacuum decay that occurs within the compression chamber 38, and prevent backflow of the lubricant from within the compression chamber 38 through the inlet 44.

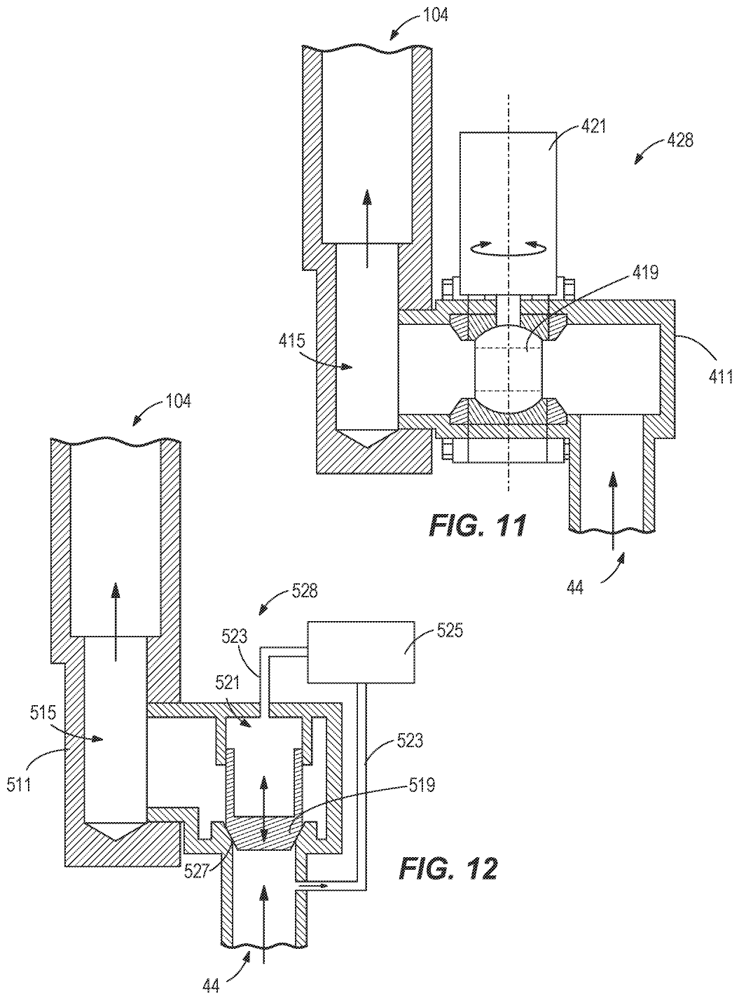

As shown in FIG. 11, a motor actuated ball valve 428 may be fluidly connected to the fluid pathway 68 extending between the inlet 44 and the pump inlet 104. In the illustrated embodiment, the motor actuated ball valve 428 includes a body 411 defining a flow path 415, and a ball valve 419, and a motor 421 configured to adjust the position of the ball valve 419 to selectively restrict flow through the flow path 315. The motor 421 may be in communication with the electronic control unit 34. When the pump assembly 42 is activated, the electronic control unit 34 sends a signal to the motor 421 to open the ball valve 419 and allow forward flow. Once the pump assembly 42 is deactivated, the electronic control unit 34 sends a signal to the motor 421 to close the ball valve 419, which restricts the fluid or material from entering the pump assembly 42, limit the amount of vacuum decay that occurs within the compression chamber 38, and prevent backflow of the lubricant from within the compression chamber 38 through the inlet 44.

As shown in FIG. 11, a pilot valve 528 may be fluidly connected to the fluid pathway 68 extending between the inlet 44 and the pump inlet 104. In the illustrated embodiment, the pilot valve 528 includes a body 511 defining a flow path 515, and a piston 519 positioned within a dome 521, and pilot tubes 523 in communication with the dome 521, the flow path 515, and a control pilot 525. When the pump assembly 42 is activated, the piston 519 is urged within the dome 521 to allow forward flow and the pressure from the dome 521 is released through the pilot tubes 523 and is exhausted out of the control pilot 525. Once the pump assembly 42 is deactivated, the pressure within the dome 521 is equalized with the pressure in the flow path to cause the piston to engage with a seat 527, which restricts the fluid or material from entering the pump assembly 42, limit the amount of vacuum decay that occurs within the compression chamber 38, and prevent backflow of the lubricant from within the compression chamber 38 through the inlet 44.

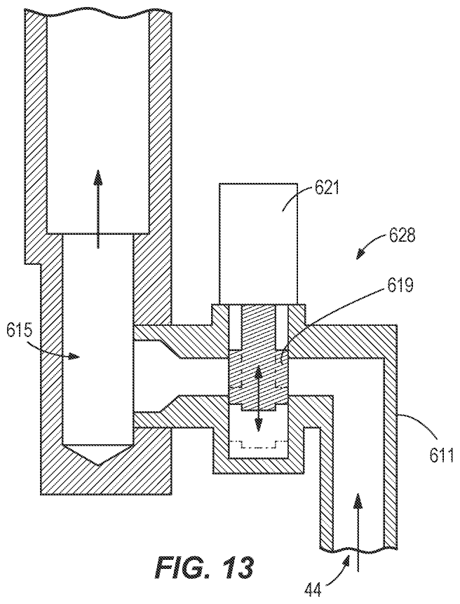

As shown in FIG. 13, a spool valve 628 may be fluidly connected to the fluid pathway 68 extending between the inlet 44 and the pump inlet 104. In the illustrated embodiment, the spool valve 628 includes a body 611 defining a flow path 615, and a spool 619, and an actuator 621 configured to adjust the position of the spool 619 to selectively restrict flow through the flow path 615. The actuator 621 may be in communication with the electronic control unit 34. When the pump assembly 42 is activated, the electronic control unit 34 signals a signal to the actuator 621 to adjust the position of the spool 619 (e.g., shown in dashed lines) to allow forward flow. Once the pump assembly 42 is deactivated, the electronic control unit 34 signals a signal to the actuator 621 close 621 the spool 619, which restricts the fluid or material from entering the pump assembly 42, limit the amount of vacuum decay that occurs within the compression chamber 38, and prevent backflow of the lubricant from within the compression chamber 38 through the inlet 44.

Although the invention has been described in detail with reference to certain preferred embodiments, variations and modifications exist within the scope and spirit of one or more independent aspects of the invention as described.

Various features of the invention are set forth in the following claims.

1. A vacuum pump comprising:
a housing defining a base, an internal cavity, and a partition wall that defines a first chamber and a second chamber within the internal cavity, the second chamber being sealed relative to the first chamber to form a compression chamber that holds a lubrication fluid;
a motor assembly positioned within the first chamber of the housing;
an electronic control unit positioned within the first chamber of the housing, the electronic control unit configured selectively activate and deactivate the motor assembly;
a pump assembly positioned within the compression chamber and in communication with the lubrication fluid and the motor assembly;
a battery coupled to the housing to provide power to the motor assembly to drive the pump assembly;
an inlet coupled to the housing to connect the vacuum pump to an external system;
a fluid pathway extending between the inlet and a pump inlet of the pump assembly; and
a valve positioned within the fluid pathway that selectively opens and closes the fluid pathway, the valve being biased towards a closed position to restrict flow through the fluid pathway.

2. The vacuum pump of claim 1, wherein:
the valve is a solenoid valve integrated within the housing and electrically connected to the electronic control unit, and
wherein the electronic control unit is configured to output an electrical current to the solenoid valve to move the solenoid valve to an open position when the motor assembly is activated.

3. The vacuum pump of claim 2, wherein the electrical current provided to the solenoid valve is interrupted when charge of the battery is depleted, which moves the solenoid valve back to the closed position to restrict flow through the fluid pathway.

4. The vacuum pump of claim 1, wherein the fluid pathway is at least partially defined in the partition wall.

5. The vacuum pump of claim 1, wherein the fluid pathway has a first portion that extends vertically from the inlet towards the base and a second portion that extends diagonally from an end of the first portion of the fluid pathway towards the pump inlet.

6. The vacuum pump of claim 1, wherein the compression chamber includes a fluid port, a fluid gauge positioned on a sidewall of the housing, a release valve positioned on the upper portion of the housing, and a fluid drain valve positioned proximate the base.

7. The vacuum pump of claim 1, wherein:
the motor assembly includes a motor and a fan driven by the motor, and
the fan is configured to remove heat from the electronic control unit and provide air to the motor to prevent overheating of each of the electronic control unit and the motor.

8. The vacuum pump of claim 1, wherein the pump assembly is a two-stage pump that has a first pump chamber and a second pump chamber in series with the first pump chamber.

9. The vacuum pump of claim 8, wherein the pump inlet fluidly communicates the first pump chamber and the fluid pathway, and wherein the first pump chamber includes an outlet in communication with the second pump chamber.

10. The vacuum pump of claim 9, wherein the second pump chamber has an outlet that releases the pressure from the pump assembly to the compression chamber.

11. The vacuum pump of claim 1, wherein:
the valve is a check valve having a body, a seat formed in the body, and a disc pivotably coupled to the body to selectively engage the seat to restrict flow through the fluid pathway,
the disc is urged out of engagement with the seat by the fluid flow when the pump is activated, and
the disc is configured to move into engagement with the seat to block reverse flow when the pump is deactivated.

12. The vacuum pump of claim 1, wherein:
the valve is a poppet valve having a body, a seat formed in the body, a plunger movable relative to the body, and a biasing member that urges the plunger into engagement with the seat,
the plunger is urged out of engagement with the seat by the fluid flow when the pump is activated, and
the biasing member urges the plunger into engagement with the seat to block reverse flow when the pump is deactivated.

13. The vacuum pump of claim 1, wherein:
the valve is a motor actuated ball valve having a body, a ball valve, and a motor configured to adjust a position of the ball valve to selectively restrict flow through the fluid pathway,
the electronic control unit is configured to send a signal to the motor to open the ball valve and allow forward flow when the pump is activated, and
the electronic control unit is configured to send a signal to the motor to close the ball valve and block reverse flow when the pump is deactivated.

14. The vacuum pump of claim 1, wherein:
the valve is a pilot valve having a body, a seat formed in the body, a dome, a piston positioned within the dome, and pilot tubes in communication with the dome, the flow path, and a control pilot,
the piston is urged within the dome to allow forward flow when the pump is activated, and
pressure within the dome is equalized with pressure in the flow path when the pump is deactivated to cause the piston to engage with the seat and block reverse flow.

15. The vacuum pump of claim 1, wherein:
the valve is a spool valve having a body, a spool, and an actuator configured to adjust a position of the spool to selectively restrict flow through the fluid pathway,
the electronic control unit is configured to output a signal to the actuator to adjust the position of the spool and allow forward flow when the pump is activated, and
the electronic control unit is configured to output a signal to the actuator to adjust the position of the spool and block reverse flow when the pump is deactivated.

16. A vacuum pump comprising:
a housing defining an internal cavity and a partition wall that defines a first chamber and a second chamber within the internal housing, the second chamber is sealed relative to the first chamber to form a compression chamber that holds a lubrication fluid;
a motor assembly positioned within the first chamber of the housing;
an electronic control unit positioned within the first chamber of the housing;
a pump assembly positioned within the compression chamber and in communication with the lubrication fluid and the motor assembly;
a battery coupled to the housing to provide power to the motor assembly to drive the pump assembly;
an inlet coupled to the housing to connect the vacuum pump to an external system;
a fluid pathway extending between the inlet and a pump inlet of the pump assembly; and
a solenoid valve positioned within the fluid pathway that selectively opens and closes the fluid pathway in response to a signal from the electronic control unit.

17. The vacuum pump of claim 16, wherein the solenoid valve is integrated within the housing and is biased towards a closed position.

18. The vacuum pump of claim 16, when the electronic control unit is configured to output an electrical current to the solenoid valve to move the solenoid valve to an open position when motor assembly is activated.

19. The vacuum pump of claim 18, wherein the electrical current provided to the solenoid valve is interrupted when charge of the battery is depleted, which moves the solenoid valve back to the closed position to close the fluid pathway.

20. The vacuum pump of claim 18, wherein the electrical current provided to the solenoid valve is interrupted when the pump is deactivated, which moves the solenoid valve back to the closed position to close the fluid pathway.

21. A vacuum pump comprising:
a housing defining a base, an internal cavity, and a partition wall that defines a first chamber and a second chamber within the internal cavity, the second chamber being sealed relative to the first chamber to form a compression chamber that holds a lubrication fluid;
a motor assembly positioned within the first chamber of the housing;
an electronic control unit positioned within the first chamber of the housing, the electronic control unit configured selectively activate and deactivate the motor assembly;
a pump assembly positioned within the compression chamber and in communication with the lubrication fluid and the motor assembly;
a battery coupled to the housing to provide power to the motor assembly to drive the pump assembly;
an inlet coupled to the housing to connect the vacuum pump to an external system; and
a fluid pathway extending between the inlet and a pump inlet of the pump assembly.
